(19) United States
(12) Patent Application Publication
(10) Pub. No.: US 2011/0187637 A1
(43) Pub. Date: Aug. 4, 2011

(54) Tactile Input Apparatus

(76) Inventor: David Scott Nichols, Vista, CA (US)

(21) Appl. No.: 12/696,441

(22) Filed: Jan. 29, 2010

(51) Int. Cl. G06F 3/044

(52) U.S. Cl. 345/156

(57) ABSTRACT

A tactile input apparatus comprising ring-shaped elements configured to conform to a user's fingers, tactile capacitance sensors operably affixed to periphery of the ring-shaped elements, and a control unit, is provided. Each tactile capacitance sensor is positioned parallel to the underside of each finger and reads a change in capacitance on contacting the user's thumb or palm. The control unit, in wired or wireless electronic communication with each tactile capacitance sensor and with the user's computing device, continuously transmits capacitance readings multiple times per second to a software on the computing device. The software monitors and processes the capacitance readings from the control unit and controls output to the computing device. The software determines logic and then enacts single or multiple custom outputs. The positioning of the tactile capacitance sensors on the periphery of the ring-shaped elements prevents confinement of the user's fingers and allows mobility of the user's fingers.

### CROSS REFERENCE TO RELATED APPLICATIONS

This application claims the benefit of provisional patent application number U.S. 61/206,115 titled “Exo Skeletal Hand Controller For Video Game Control And Physical Rehabilitation”, filed on Jan. 29, 2009 at the United States Patent And Trademark Office.

The specification of the above referenced patent application in incorporated herein by reference in its entirety.

### BACKGROUND

Computer and video game console peripheral device technology and popularity have increased tremendously in recent years. Computer games have grown tremendously in sophistication, and so have the number of constituent commands required to play some of today's most popular games. Video-gaming using a personal computer requires a user to employ a keyboard and a mouse as physical control interfaces, or requires the user to utilize some other form of third-party game controller via a serial connection. The different keystrokes required to control some of today's games can be difficult to commit to memory. As a result, some games cannot be easily controlled by a user. Many users opt for joysticks and control pads. However, extended and long term use of devices associated with games and other applications cause repetitive stress injuries.

A few video game controllers are glove shaped and are worn on the hand. In order to wear glove shaped controllers, a user is required to calibrate the controller to conform to the shape of the user's hand. Therefore, different users cannot readily use such controllers due to size restrictions, shape requirements, etc. Moreover, when the user wears such a controller, the user feels restrained because of the glove-like shape of the controller. Moreover, physical contact with the glove shaped controller is restrictive and does not allow ease of mobility of the user's fingers. Since the palm and fingertips of the user's hand are covered with the glove shaped controller, work and operation of the user's fingers are hindered. Therefore, the user cannot always wear the glove shaped controller during operation. Hence, there is a need for a peripheral input apparatus that is as least restrictive as possible and allows ease of movement of the user's fingers when in use. Furthermore, the fabric and structure of the glove shaped controllers establish a large contact area with the user's skin, which causes the user's hand to perspire. Therefore, there is a need for a peripheral input apparatus that provides minimal contact area with the user's fingers and minimizes the potential problem of perspiration in hand-worn peripheral technology.

Hence, there is a long felt but unresolved need for an ergonomic and user-friendly input apparatus for use with devices, for example, personal computers and video game consoles, that minimizes contact area with the user's fingers to reduce perspiration, allows mobility of the user's fingers, allows ease of operation, and increases the level of comfort to the user.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The tactile input apparatus and method disclosed herein addresses the above stated need for an ergonomic and user-friendly apparatus for use with devices, for example, personal computers and video game consoles, that minimizes contact area with the user's fingers to reduce perspiration, allows mobility of the user's fingers, enables ease of operation, and increases the level of comfort to the user. The tactile input apparatus disclosed herein is lightweight, worn on the fingertips, and utilizes change in capacitance of tactile capacitance sensors to provide logic for controls or emulation. The tactile input apparatus disclosed herein is a finger tip based touch sensing user interface device for applications such as video game control, keyboard and button emulation, educational, industrial, and physical rehabilitation applications for the users' fingers, hands, and wrist.

The tactile input apparatus disclosed herein comprises generally ring-shaped elements, tactile capacitance sensors, and a control unit. The generally ring-shaped elements, herein referred to as “rings”, are configured to conform to a user's fingers. The rings are mounted on the user's fingers. The tactile capacitance sensors are operably affixed to the periphery of the rings. When mounted on the user's fingers, each tactile capacitance sensor is positioned adjacent and parallel to the underside of each of the user's fingers. The positioning of the tactile capacitance sensors on the periphery of the rings prevents confinement of the user's fingers and hand and allows mobility of the user's fingers. Each of the tactile capacitance sensors undergoes a change in capacitance on establishing contact with the user's finger, thumb or palm.

The control unit is in electronic communication with each of the tactile capacitance sensors positioned on the rings. The electronic communication between each of the tactile capacitance sensors and the control unit is, for example, a wired communication, a wireless communication, or a combination thereof. The control unit monitors each of the tactile capacitance sensors and continuously transmits the capacitance readings of each of the tactile capacitance sensors to the computing device. The control unit comprises a capacitance touch sensing chip and a microcontroller for monitoring each of the tactile capacitance sensors on the periphery of the rings and for capturing and transmitting the capacitance readings of the tactile capacitance sensors. The control unit utilizes the capacitance touch sensing chip and the microcontroller to detect and assign logic to the captured capacitance readings of each of the tactile capacitance sensors.

In an embodiment, the control unit is mounted on the periphery of each of the rings and is, for example, in a wired communication or a wireless communication with the computing device. In another embodiment, the control unit is mounted external to each of the rings and is, for example, in a wired communication or a wireless communication with the computing device. In an embodiment, shielded wires may be provided for communicating the capacitance readings to the control unit. The wires extend from each of the tactile capacitance sensors on the periphery of the rings to the control unit. In an embodiment, the extended wires are grouped and attached to a band wearable on the user's wrist.

Furthermore, the control unit is in electronic communication with a software provided on the user's computing device. The control unit continuously transmits the capacitance readings to the software on the user's computing device. The software receives and processes the capacitance readings into one or more custom outputs on the computing device. The electronic communication between the control unit and the computing device is, for example, a wired communication, a wireless communication, or a combination thereof. The user provides input by contacting the user's thumb or palm to one or more of the tactile capacitance sensors on the periphery of the rings. The contact invokes a change in capacitance of the tactile capacitance sensors. The software processes the input by monitoring the capacitance readings of each of the tactile capacitance sensors on the rings on respective fingers and translates the capacitance readings into logic based on change in capacitance. The software emulates the input by mapping the tactile capacitance sensors positioned on the periphery of the rings to an action on the computing device. In an embodiment, the software provides a graphical user interface to enable the user to customize emulation of single or multiple output actions on the computing device, for example, emulation of a keystroke.

In an embodiment, the tactile input apparatus further comprises a radio frequency transceiver on each of the tactile capacitance sensors and the control unit for wirelessly communicating with the control unit and the computing device respectively. In another embodiment, the tactile input apparatus further comprises an energy storage device mounted on each of the rings for powering the tactile capacitance sensors and the control unit. In another embodiment, a wireless power source is provided for transferring power to each of the tactile capacitance sensors on the periphery of the rings via, for example, near field induction, electrostatic or electrodynamic induction, capacitance coupling, etc.

The tactile input apparatus disclosed herein accurately emulates a user input device using a simple tap of the user's thumb to another finger thereby incurring very little to no repetitive physical stress. The tactile input apparatus disclosed herein provides smooth palm and clutter-free finger movement that allows the user to type and freely manipulate hand held objects. The software installed on the computing device monitors the change in capacitance and processes a desired action, wherein the user can map or assign a particular action such as an emulated keystroke to an individual tactile capacitance sensor on the user's finger. The tactile input apparatus disclosed herein uses solid-state, single-layer-printed circuit board touch sensors and can be configured to function as a standalone device or in conjunction with external devices, for example, an exoskeletal framework. The tactile capacitance sensors and rings are small in size and provide minimal contact area with the fingers, thereby minimizing perspiration of the user's hand. Since the act of tapping the user's thumb to another finger is ingrained and natural to a user, the tactile input apparatus disclosed herein provides an increased level of comfort for the user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a block diagram of a tactile input apparatus used for providing input to a computing device of a user.

FIG. 2 exemplarily illustrates a top perspective view of a tactile capacitance sensor operably affixed to the periphery of a ring-shaped element of the tactile input apparatus, where the tactile capacitance sensor is positioned adjacent and parallel to the underside of a user's finger.

FIG. 3 exemplarily illustrates a side orthogonal view of the tactile capacitance sensor operably affixed to the periphery of the ring-shaped element, where the tactile capacitance sensor is positioned adjacent and parallel to the underside of the user's finger.

FIG. 4 exemplarily illustrates a bottom orthogonal view of the tactile capacitance sensor operably affixed to the periphery of the ring-shaped element, where the tactile capacitance sensor is positioned adjacent and parallel to the underside of the user's finger.

FIG. 5 exemplarily illustrates a wire arrangement of the tactile input apparatus.

FIGS. 6A-6B exemplarily illustrate a cutaway view showing wires extending from a tactile capacitance sensor positioned on a ring shaped element on the finger to a mounting pad attached to a band wearable on the user's wrist.

FIG. 7 exemplarily illustrates a circuit diagram of the tactile input apparatus in wired communication with a user's computing device via a control unit.

FIG. 8 exemplarily illustrates a block diagram representation of the tactile input apparatus in wired communication with the computing device via integrated circuitry.

FIG. 9A exemplarily illustrates a block diagram of the tactile input apparatus in wireless communication with a computing device of a user via a wired connection with a control unit.

FIG. 9B exemplarily illustrates an embodiment of the tactile input apparatus in wireless communication with a computing device of a user via a wireless connection with the control unit.

FIG. 9C exemplarily illustrates another embodiment of the tactile input apparatus in wireless communication with a computing device of a user via a wireless connection with the control unit.

FIG. 10 exemplarily illustrates a top perspective view of the tactile input apparatus worn on a user's hand, where wires extend from the tactile capacitance sensors on the periphery of the ring-shaped elements and are attached to a band wearable on the user's wrist.

FIG. 11 exemplarily illustrates a top perspective view of the tactile input apparatus worn on a user's hand, where the tactile capacitance sensors on the periphery of the ring-shaped elements wirelessly communicate with a control unit mounted on a band wearable on the user's wrist.

FIG. 12 exemplarily illustrates a graphic user interface provided by a software on a computing device of a user for enabling the user to customize emulation of single or multiple output actions on the computing device.

FIG. 13 exemplarily illustrates a method for providing input to a computing device by a user.

FIG. 14 exemplarily illustrates the architecture of a computer system employed for processing capacitance readings of each of the tactile capacitance sensors into custom outputs on the computing device.

### DETAILED DESCRIPTION OF THE INVENTION

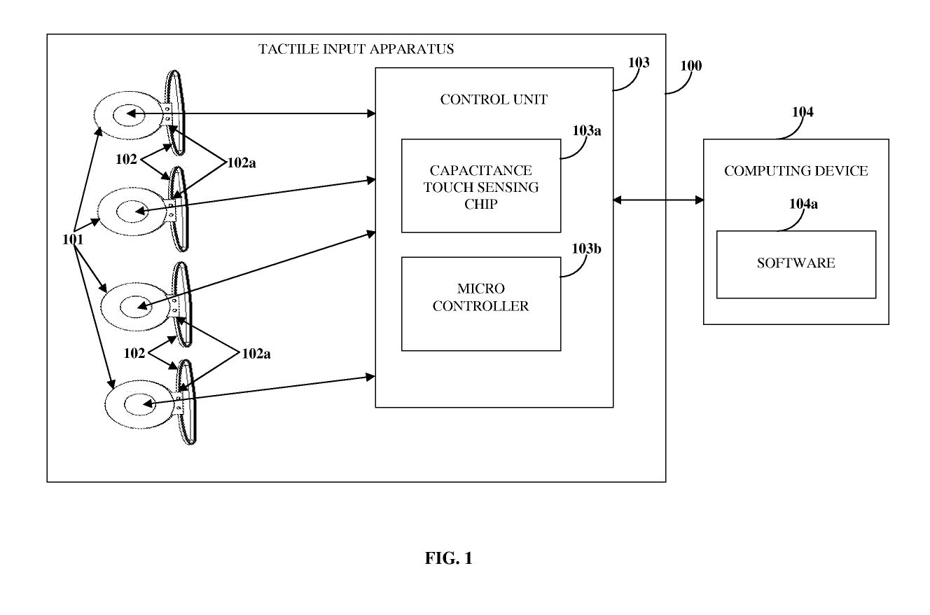

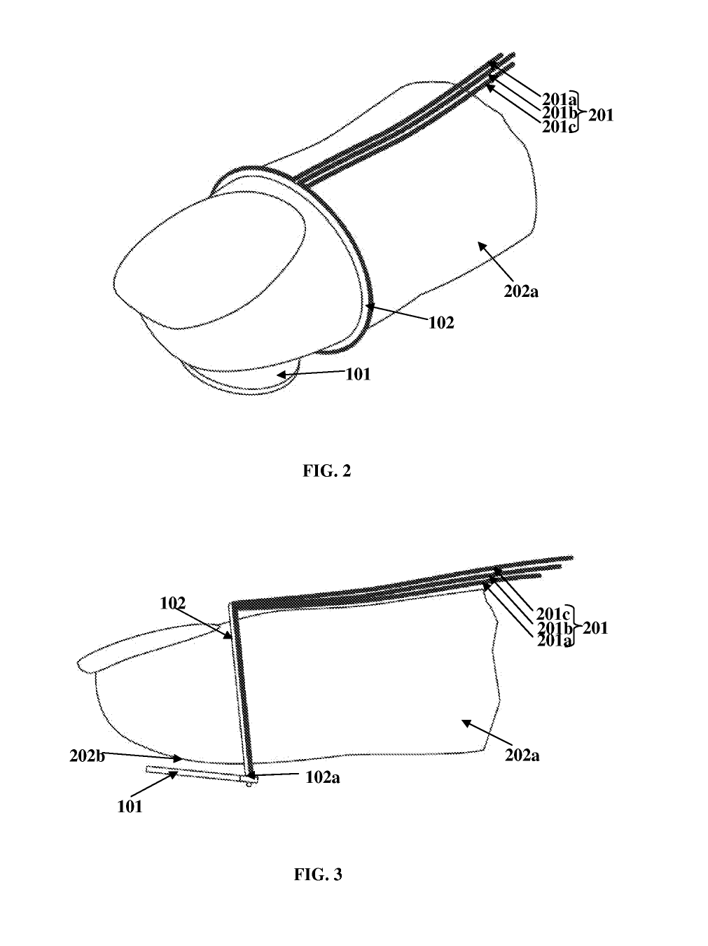

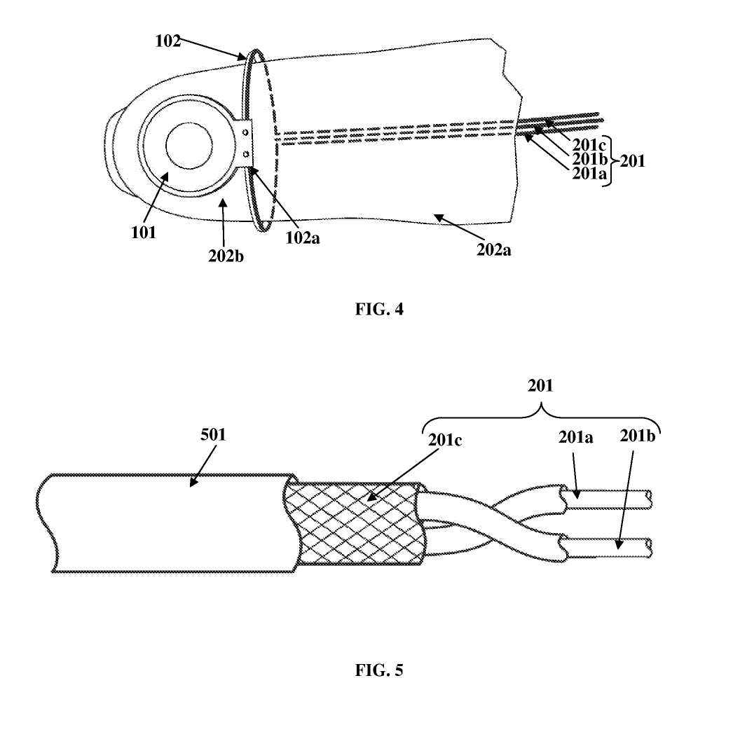

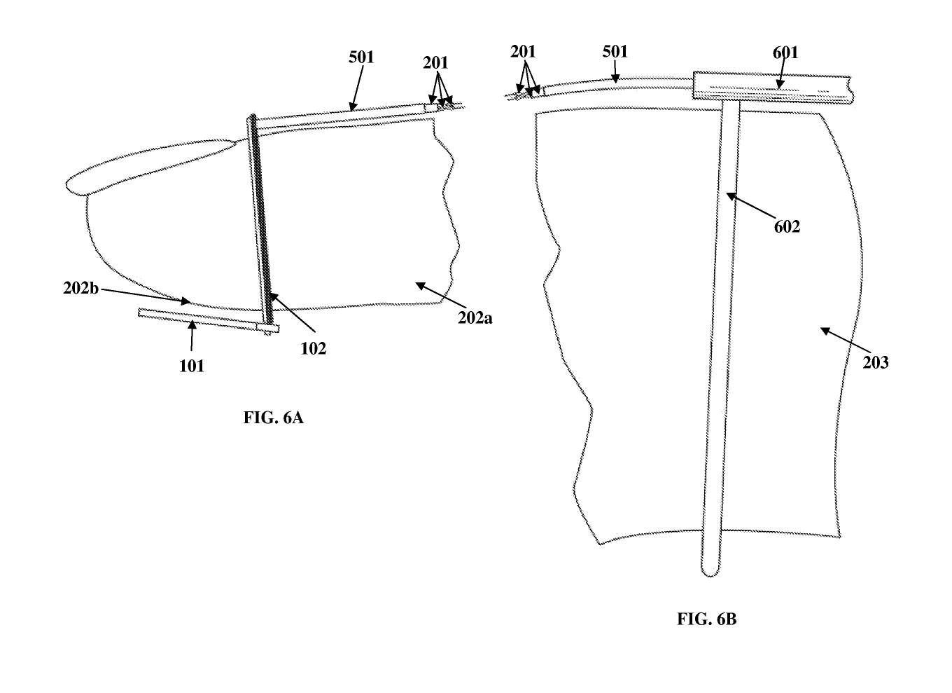

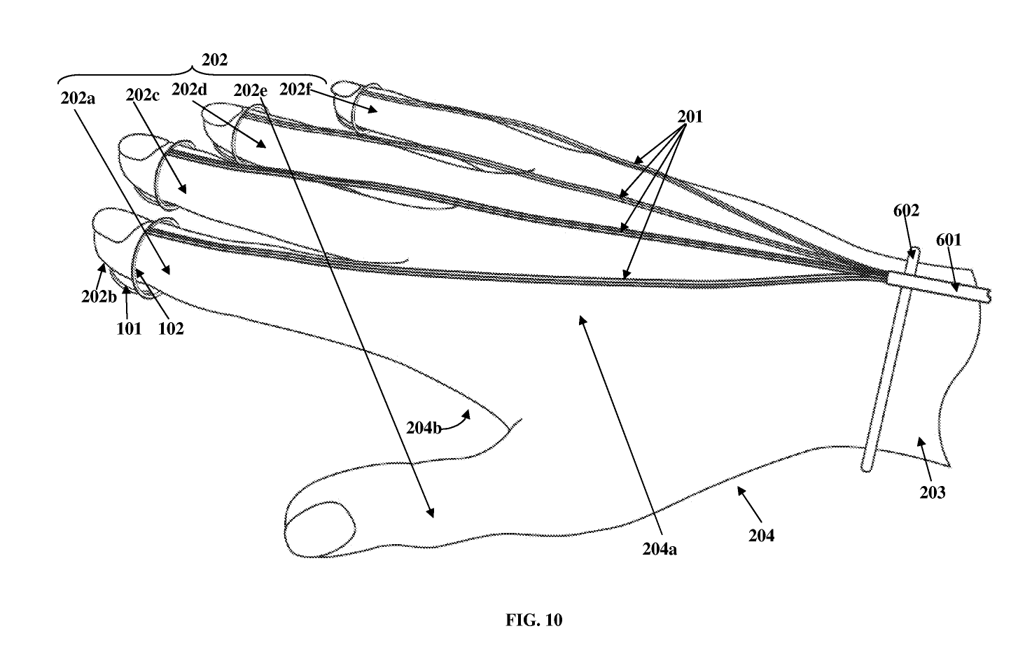

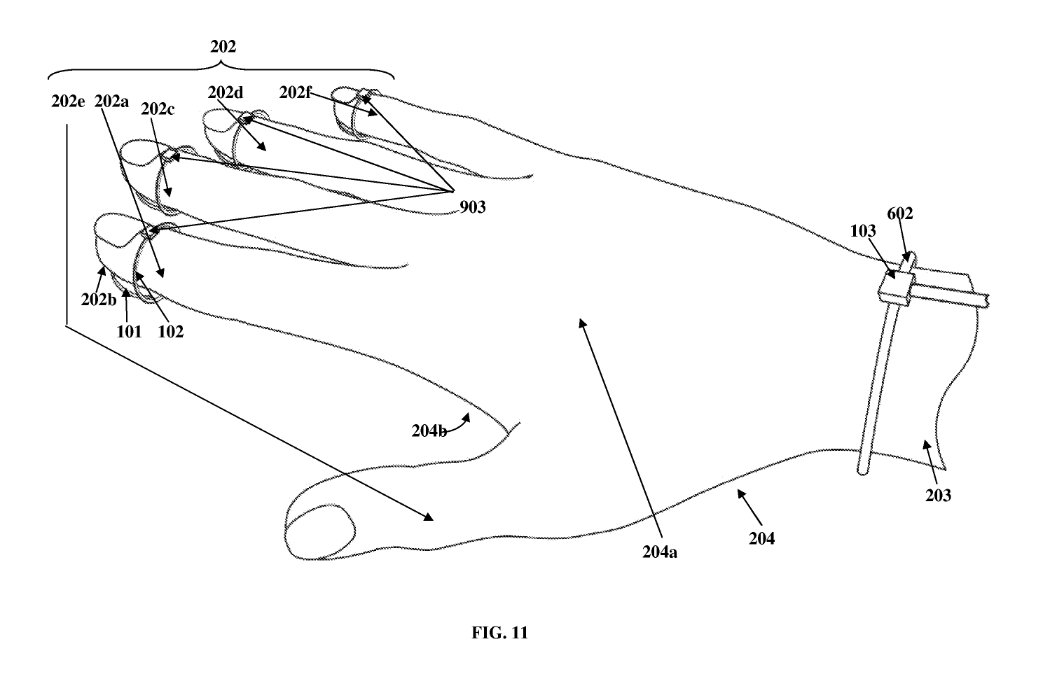

FIG. 1 illustrates a block diagram of a tactile input apparatus 100 used for providing input to a computing device 104 of a user. The tactile input apparatus 100 disclosed herein comprises generally ring-shaped elements 102, tactile capacitance sensors 101, and a control unit 103. The generally ring-shaped elements 102, herein referred to as “rings”, are configured to conform to a user's fingers 202 as exemplarily illustrated in FIGS. 10-11. The rings 102 are mounted on the user's fingers 202 as exemplarily illustrated in FIGS. 2-4 and FIGS. 10-11. The rings 102 are, for example, made of plastic, polymeric materials, rubber, metal, etc. The rings 102 may be coated with a synthetic rubber seal to provide flexibility. The tactile capacitance sensors 101 are operably affixed to the periphery 102a of the rings 102. Each tactile capacitance sensor 101 is positioned adjacent and parallel to the underside 202b of each of the user's fingers 202 as exemplarily illustrated in FIGS. 2-4 and FIGS. 10-11. Each of the tactile capacitance sensors 101 undergoes a change in capacitance on establishing contact with one of the user's fingers 202, for example, the user's thumb 202e, or the user's palm 204b.

The control unit 103 is in electronic communication with each of the tactile capacitance sensors 101 positioned on the rings 102. The electronic communication between each of the tactile capacitance sensors 101 and the control unit 103 is, for example, a wired communication, a wireless communication, or a combination thereof. As used herein, “wired communication” refers to transmission of signals such as capacitance reading signals, using electrical conductors such as wires 201. Also, as used herein, “wireless communication” refers to transmission of capacitance reading signals using, for example, radio frequency transmission.

The control unit 103 monitors each of the tactile capacitance sensors 101 and continuously captures capacitance readings of each of the tactile capacitance sensors 101. The control unit 103 comprises a capacitance touch sensing chip 103a and a microcontroller 103b for monitoring each of the tactile capacitance sensors 101 on the periphery 102a of the rings 102 and for capturing the capacitance readings of the tactile capacitance sensors 101. The control unit 103 utilizes the capacitance touch sensing chip 103a and the microcontroller 103b to detect and assign logic to the captured capacitance readings of each of the tactile capacitance sensors 101.

The control unit 103 is also in electronic communication with a software 104a provided on the user's computing device 104 for continuously transmitting the capacitance readings. The software 104a is, for example, an application, a service, a driver implemented on a Microsoft Windows®, platforms of Apple Inc., and/or a Linux platform, dynamic link libraries, etc. The computing device 104 is, for example, a video game console, a mobile device, a personal digital assistant, a personal computer (PC) using software platforms such as Windows®, Linux, Apple, etc. The electronic communication between the control unit 103 and the computing device 104 is, for example, a wired communication, a wireless communication, or a combination thereof. The control unit 103 continuously reports the respective capacitance readings to the software 104a on the user's computing device 104. The software 104a receives and translates the capacitance readings to one or more custom outputs on the computing device 104.

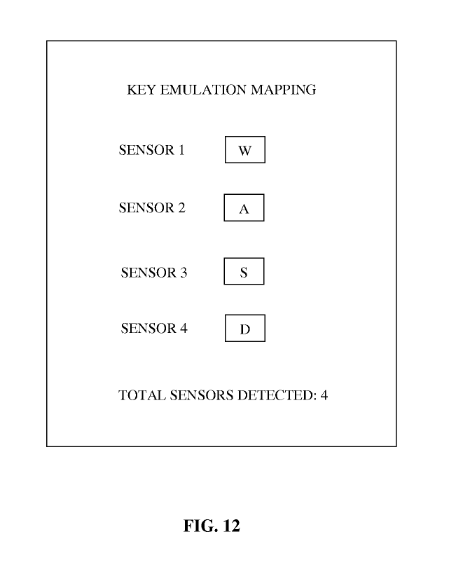

The user provides input by contacting the user's thumb 202e or palm 204b with one or more tactile capacitance sensors 101 on the periphery 102a of the rings 102. The user may also establish contact with the tactile capacitance sensors 101 on the fingers 202 of one hand 204 by using the bare fingers of the other hand to provide input. The contact invokes the change in capacitance of the tactile capacitance sensors 101. The software 104a emulates the input by mapping the tactile capacitance sensors 101 positioned on periphery 102a of the rings 102 to an action on the computing device 104. The software 104a provides a graphical user interface (GUI), as exemplarily illustrated in FIG. 12, for enabling the user to customize emulation of multiple output actions on the computing device 104.

The four fingers 202a, 202c, 202d, and 202f of the user's hand 204, as illustrated in FIGS. 10-11, can each be mapped or assigned by the software 104a to, for example, a particular key on a keyboard, or button on a joystick, etc. The tactile input apparatus 100 disclosed herein enables a user to control video games and computing devices, and is used in applications in the areas of education, industry, entertainment, physical rehabilitation, etc.

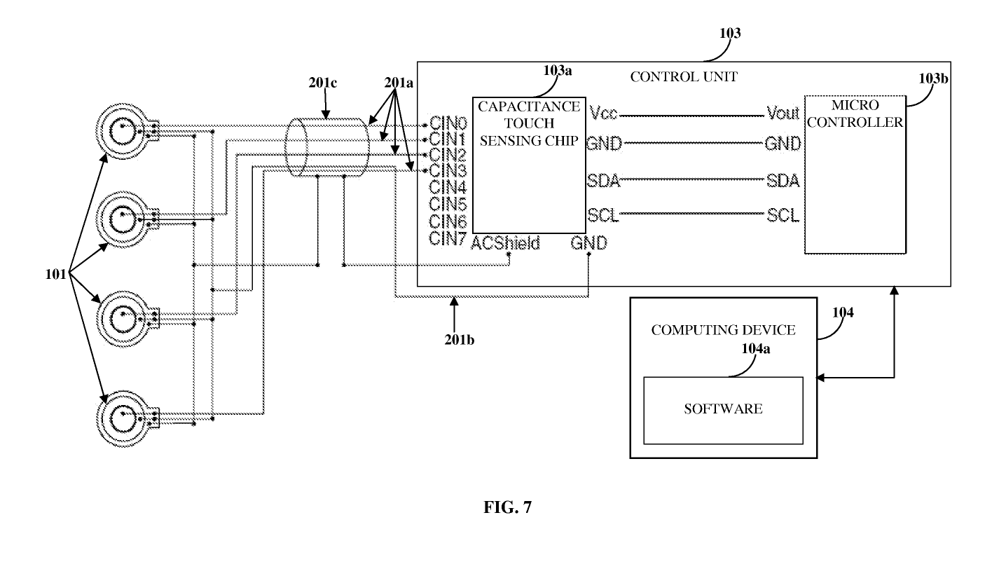

FIGS. 2-4 exemplarily illustrate a top perspective view, a side orthogonal view, and a bottom orthogonal view of a tactile capacitance sensor 101 operably affixed to the periphery 102a of a ring 102 respectively. The tactile capacitance sensor 101 is positioned adjacent and parallel to the underside 202b of the user's finger, for example the index finger 202a. As exemplarily illustrated in FIGS. 2-4, the ring 102 encircles the finger 202a and the tactile capacitance sensor 101 comes in close contact to the underside 202b of the user's finger 202a. The positioning of the tactile capacitance sensors 101 on the periphery 102a of the rings 102 prevents confinement of the user's fingers 202 and hand 204, and allows mobility of the user's fingers 202. In an embodiment, shielded wires 201 extend from each tactile capacitance sensor 101 on the periphery 102a of each of the rings 102 to the control unit 103 for communicating the capacitance readings to the control unit 103. As exemplarily illustrated in FIGS. 2-4, three wires 201 extending from the tactile capacitance sensor 101 constitute a capacitance loop. The first wire 201a is a conductor. The second wire 201b is the ground. The third wire 201c is an alternating current (AC) shielding wire. For simplicity, the third wire 201c is not shown as a mesh or foil shield or as a twisted embodiment, but rather as a single wire in FIGS. 2-4. The third wire 201c could take on many different forms such as a mesh or foil shield around the first wire 201a and the second wire 201b as exemplarily illustrated in FIG. 5. The third wire 201c can also be a conductor twisted around the first wire 201a and the second wire 201b.

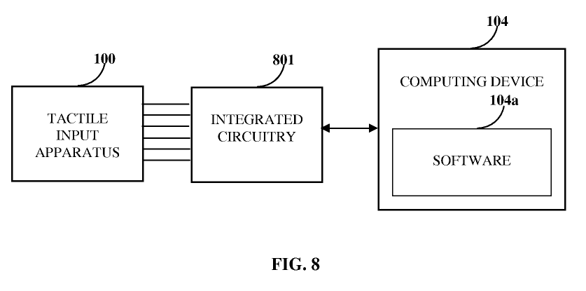

FIG. 5 exemplarily illustrates a wire arrangement of the tactile input apparatus 100. As exemplarily illustrated in FIG. 5, the third wire 201c, that is the AC shielding wire, is in the form of a mesh or foil shielding positioned around the first wire 201a and the second wire 201b. The first wire 201a and the second wire 201b constitute a twisted wire arrangement as illustrated in FIG. 5. The mesh or foil shielding around the twisted wire arrangement of the first wire 201a and the second wire 201b is enclosed in a wire jacket 501. The wire jacket 501 enclosing the third wire 201c, the first wire 201a, and the second wire 201b extends from the tactile capacitance sensor 101 on the ring 102 mounted on the user's finger 202a to a mounting pad 601 attached to a band 602 wearable on the user's wrist 203 as exemplarily illustrated in FIGS. 6A-6B.

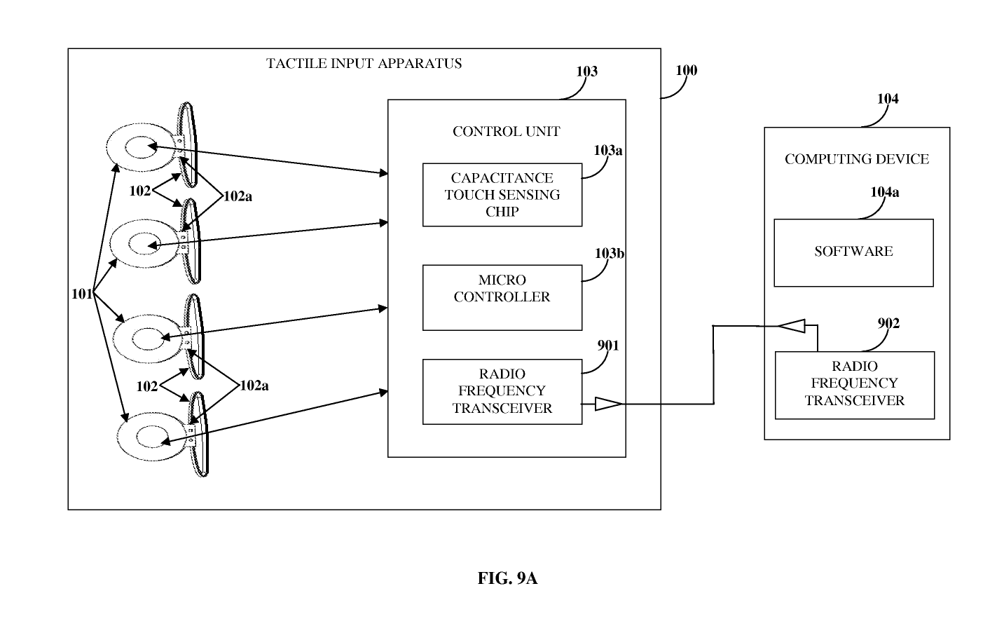

FIG. 7 exemplarily illustrates a circuit diagram of the tactile input apparatus 100 in wired communication with a user's computing device 104 via a control unit 103. The tactile capacitance sensors 101 sense capacitance. Each of the tactile capacitance sensors 101 undergoes a change in capacitance on establishing contact with the user's thumb 202e or palm 204b. Each of the tactile capacitance sensors 101 is connected to the control unit 103 by, for example, wires 201 to communicate the capacitance readings to the control unit 103. The control unit 103 comprises a capacitance touch sensing chip 103a and a microcontroller 103b as disclosed in the detailed description of FIG. 1. The control unit 103 utilizes the capacitance touch sensing chip 103a and the microcontroller 103b to detect and assign logic to the captured capacitance readings of each of the tactile capacitance sensors 101. The capacitance touch sensing chip 103a comprises, for example, a ground (GND) pin, a serial data pin, a serial clock pin, capacitance sensor input pins CIN0, CIN1, CIN2, CIN3, CIN4, CIN5, CIN6, and CIN7, an alternating current (AC) shield pin, a voltage input pin (Vcc), etc. The first wire 201a, the second wire 201b, and the third wire 201c as disclosed in the detailed description of FIGS. 2-5 are connected to the capacitance touch sensing chip 103a of the control unit 103. The first wire 201a of each of the tactile capacitance sensors 101 is connected to the capacitance sensor input pins of the capacitance touch sensing chip 103a. The second wire 201b of each of the tactile capacitance sensors 101 is connected to the ground pin of the capacitance touch sensing chip 103a. The third wire 201c of each of the tactile capacitance sensors 101 is connected to the AC shield pin of the capacitance touch sensing chip 103a.

The microcontroller 103b comprises, for example, a voltage output pin, a ground pin, a serial data pin, and a serial clock pin, etc. The microcontroller 103b uses, for example, an inter-integrated circuit (I2C) serial connection to communicate with the capacitance touch sensing chip 103a in a standardized data transfer format. The I2C serial connection utilizes a serial data pin (SDA) and a serial clock pin (SCL) to transmit capacitance readings from the capacitance touch sensing chip 103a to the microcontroller 103b. The shielded third wire 201c from the capacitance touch sensing chip 103a to the tactile capacitance sensor 101 provides protection against interference in the form of background capacitance. The control unit 103 communicates with the software 104a provided on the user's computing device 104. The user's computing device 104 is, for example, a personal computer (PC) or a Macintosh (MAC) computer. The software 104a receives and translates the capacitance readings to one or more custom outputs on the computing device 104. The electronic communication between the control unit 103 and the computing device 104 is, for example, a wired universal serial bus (USB) 2.0 data interface. The software 104a has different versions to provide support for multiple software platforms, for example, Windows, Linux, Macintosh, etc.

Each of the tactile capacitance sensors 101 operates by measuring changes in its capacitance. When the user's bare thumb 202e touches the tactile capacitance sensor 101 on the underside 202b of one of the fingers 202a, 202c, 202d or 202f, the bare thumb 202e causes the capacitance of the tactile capacitance sensor 101 to drop from a high capacitance reading of, for example, 2000 picofarads, to a lower reading, ideally zero. Many conditions, for example, wire length, affect the actual capacitance readings. The control unit 103 monitoring each of the tactile capacitance sensors 101 captures the capacitance readings of the tactile capacitance sensors 101 and continuously reports the capacitance readings to the software 104a. The software 104a in the computing device 104 receives and translates the capacitance readings to a logic that triggers single and/or multiple output signals on the computing device 104.

In an embodiment, the control unit 103 is mounted on the periphery 102a of each of the rings 102 and is in wired or wireless communication with the computing device 104. In another embodiment, the control unit 103 is mounted external to each of the rings 102 and is in wired or wireless communication with the computing device 104.

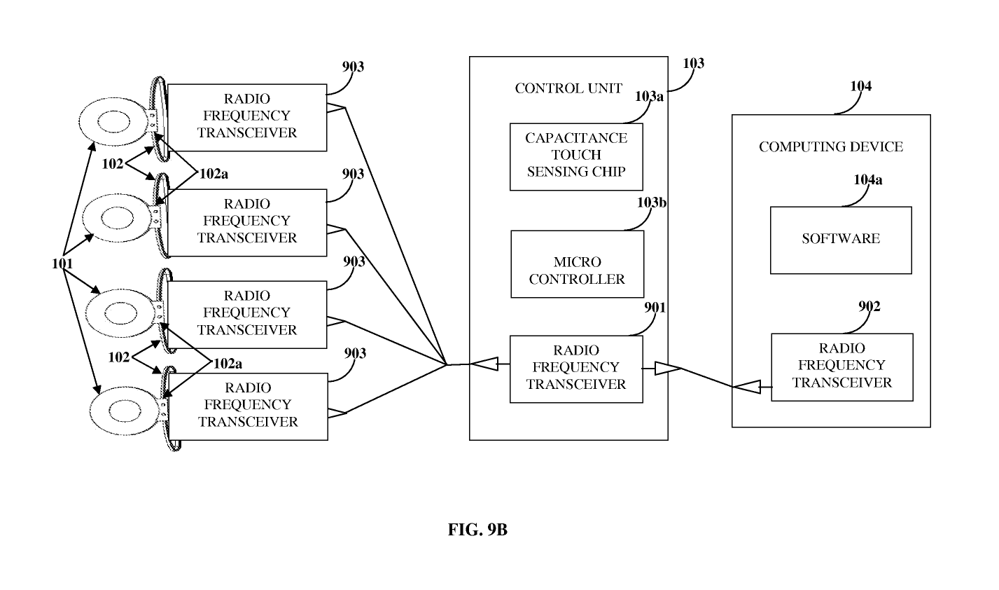

FIG. 8 exemplarily illustrates a block diagram representation of the tactile input apparatus 100 in wired communication with the computing device 104 via integrated circuitry 801. The integrated circuitry 801 enables the control unit 103 to detect the tactile capacitance sensors 101 of the tactile input apparatus 100 and to capture capacitance readings from each of the detected tactile capacitance sensors 101. The integrated circuitry 801 enables the control unit 103 to continuously monitor the tactile capacitance sensors 101 and report the capacitance readings to the software 104a on the user's computing device 104.

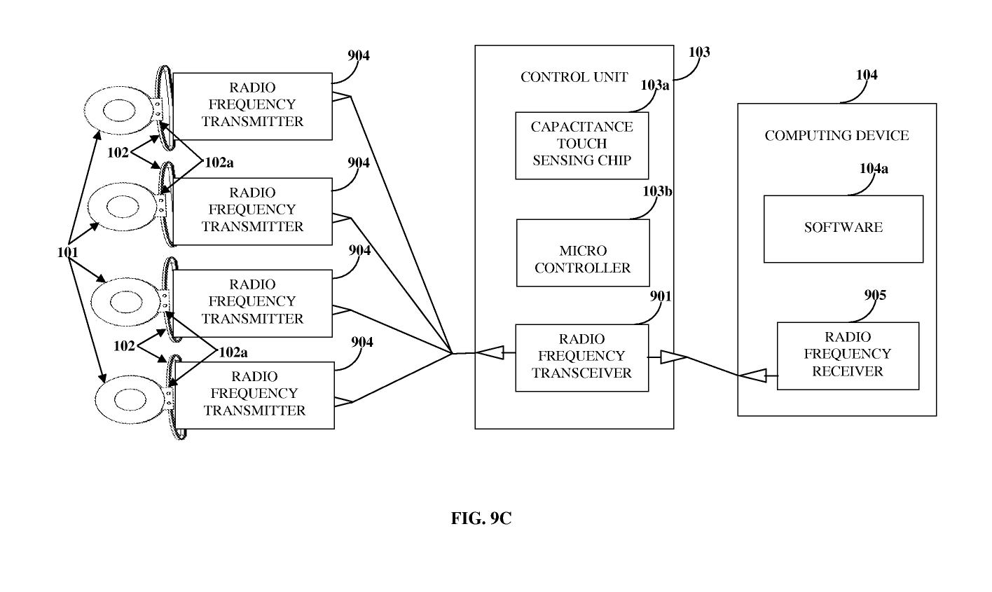

FIG. 9A exemplarily illustrates a block diagram of the tactile input apparatus 100 in wireless communication with a computing device 104 of a user via a wired connection with a control unit 103. The tactile capacitance sensors 101 sense capacitance. Each of the tactile capacitance sensors 101 undergoes a change in capacitance on contacting the user's thumb 202e, palm 204b, or fingers of the other hand. The tactile capacitance sensors 101 transmit the capacitance readings to the control unit 103 via the wired connection. The control unit 103 comprises a capacitance touch sensing chip 103a, a microcontroller 103b, and a radio frequency transceiver 901. The control unit 103 monitors the tactile capacitance sensor 101 and captures the capacitance readings of the tactile capacitance sensor 101. The control unit 103 utilizes the capacitance touch sensing chip 103a and the microcontroller 103b to detect and assign logic to the captured capacitance readings of the tactile capacitance sensor 101. As exemplarily illustrated in FIG. 9A, the radio frequency transceiver 901 is provided for enabling wireless communication between the control unit 103 and the computing device 104. For example, the radio frequency transceiver 901 fitted on the control unit 103 communicates with the radio frequency transceiver 902 fitted on the user's computing device 104. The capacitance readings are wirelessly transmitted from the control unit 103 to the computing device 104 via the radio frequency transceivers 901 and 902. The software 104a running in the computing device 104 receives and translates the capacitance readings to single or multiple outputs on the computing device 104.

FIG. 9B exemplarily illustrates an embodiment of the tactile input apparatus 100 in wireless communication with a computing device 104 of a user via a wireless connection with the control unit 103. In this embodiment, a radio frequency transceiver 903 is mounted on the periphery 102a of each of the rings 102. Tactile capacitance sensors 101 are operably affixed to the periphery 102a of the rings 102. The tactile capacitance sensors 101 sense capacitance. Each of the tactile capacitance sensors 101 undergoes a change in capacitance on contacting the user's thumb 202e or palm 204b. The radio frequency transceiver 903 on each of the rings 102 communicates with the radio frequency transceiver 901 mounted on the control unit 103 and transmits the capacitance readings of each of the tactile capacitance sensors 101. The radio frequency transceiver 901 fitted on the control unit 103 also communicates with another radio frequency transceiver 902 fitted on the user's computing device 104 to transmit the capacitance readings to the user's computing device 104. The software 104a running in the computing device 104 wirelessly receives and translates the capacitance readings to one or more custom outputs on the computing device 104 via the radio frequency transceivers 901 and 902.

FIG. 9C exemplarily illustrates another embodiment of the tactile input apparatus 100 in wireless communication with a computing device 104 of a user via a wireless connection with the control unit 103. In this embodiment, a radio frequency transmitter 904 is mounted on the periphery 102a of each of the rings 102 for enabling wireless communication with the control unit 103. The control unit 103 comprises the radio frequency transceiver 901. The computing device 104 comprises a radio frequency receiver 905. When the user's bare thumb 202e or palm 204b establishes contact with each of the tactile capacitance sensors 101, each of the tactile capacitance sensors 101 undergoes a change in capacitance. The radio frequency transmitter 904 on each of the rings 102 transmits the capacitance readings to the radio frequency transceiver 901 of the control unit 103. The radio frequency transceiver 901 of the control unit 103 continuously transmits the capacitance readings to the radio frequency receiver 905 on the computing device 104. The software 104a retrieves the transmitted capacitance readings and processes them into one or more custom outputs on the computing device 104.

In another embodiment, the tactile input apparatus 100 further comprises an energy storage device (not shown), for example, a battery, mounted on each of the rings 102 for powering the tactile capacitance sensors 101 and the control unit 103. In another embodiment, a wireless power source (not shown) is provided for transferring power to each of the tactile capacitance sensors 101 on the periphery 102a of the rings 102 via, for example, near field communication. “Near Field” magnetic induction systems employ wireless transmission techniques over distances comparable to, or a few times the diameter of the power source, and up to around a quarter of the wavelengths used. Near field energy itself is non radiative, but some radiative losses occur. In addition, there are usually resistive losses. Near field transfer is usually magnetic or inductive, but electric or capacitive energy transfer can also occur. In wireless near field embodiments, the wireless power source would need to be in close proximity to the rings 102.

FIG. 10 exemplarily illustrates a top perspective view of the tactile input apparatus 100 worn on a user's hand 204, where wires 201 extend from the tactile capacitance sensors 101 on the periphery 102a of the rings 102 and are attached to a band 602 wearable by the user. The band 602 may be fitted on the user's wrist 203. The extended wires 201 are grouped on a mounting pad 601 as illustrated in FIGS. 6A-6B. The mounting pad 601 may be attached to the band 602 wearable around the user's wrist 203. In an embodiment, the tactile input apparatus 100 disclosed herein comprises shielded wires 201 extending from the rings 102 over the back or top 204a of the hand 204 to a band 602, for example, a bracelet on the user's wrist 203 or clasp onto the user's sleeve (not shown). The shielded wires 201 provide protected, streaming capacitance data for proper functionality. The control unit 103 may be mounted in a case that attaches to the user's waist.

The tactile input apparatus 100 disclosed herein is used for example, applications such as virtual reality simulations, video game control, educational instruction, industrial controls, and physical rehabilitation of the fingers 202, hand 204, wrist 203, etc.

FIG. 11 exemplarily illustrates a top perspective view of the tactile input apparatus 100 worn on a user's hand 204, where the tactile capacitance sensors 101 on the periphery 102a of the rings 102 wirelessly communicate with a control unit 103 mounted on the band 602 wearable on the user's wrist 203. The control unit 103 is mounted on a bracelet on the user's wrist 203 or is attached onto the user's sleeve, or is mounted remotely onto a base station case near the computing device 104. The tactile capacitance sensor 101 senses capacitance, which is its ability to hold an electrical charge. The tactile capacitance sensor 101 undergoes change in capacitance on contacting the user's thumb 202e. A radio frequency transceiver 903 is operably affixed to the periphery 102a of each of the rings 102. The radio frequency transceiver 903 communicates with another radio frequency transceiver 901 fitted on the control unit 103 as disclosed in the detailed description of FIG. 9B. The control unit 103 communicates with the software 104a provided on the user's computing device 104. The software 104a receives and translates the capacitance readings to one or more custom outputs on the computing device 104.

FIG. 12 exemplarily illustrates a graphic user interface (GUI) provided by the software 104a on the user's computing device 104 for enabling the user to customize emulation of single or multiple output actions on the computing device 104. The user clicks in a field provide on the GUI for each tactile capacitance sensor 101 and maps or assigns, for example, a keystroke output based upon the logic of the software 104a. As exemplarily illustrated in FIG. 12, four tactile capacitance sensors 101, for example, sensor 1, sensor, 2, sensor 3, and sensor 4, are detected by the software 104a on the computing device 104. Sensor 1 is mapped to the keystroke “W” of the keyboard. Sensor 2 is mapped to the keystroke “A” of the keyboard. Sensor 3 is mapped to the keystroke “S” of the keyboard. Sensor 4 is mapped to the keystroke “D” of the keyboard. This mapping of tactile capacitance sensors 101 causes the computing device 104 to process the above key strokes when respective tactile capacitance sensors 101 are contacted by the user's thumb 202e or palm 204b.

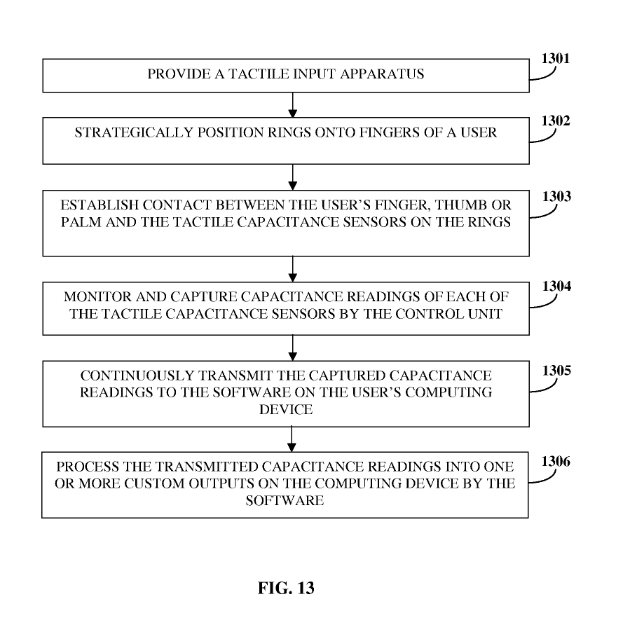

FIG. 13 exemplarily illustrates a method for providing input to a computing device 104 by a user. A tactile input apparatus 100 is provided 1301 as disclosed in the detailed description of FIGS. 1-4. At least four rings 102 are strategically positioned 1302 onto four of the user's fingers 202a, 202c, 202d, and 202f as exemplarily illustrated in FIGS. 10-11. A contact between the user's thumb 202e or palm 204b and one or more of the tactile capacitance sensors 101 is established 1303 which causes a change in capacitance of the tactile capacitance sensors 101. The capacitance readings are communicated to the control unit 103 by wired communication or wireless communication. The wired communication is established using multiple wires 201 extending from each of the tactile capacitance sensors 101 to the control unit 103 as disclosed in the detailed description of FIGS. 2-8. The wireless communication is established using a radio frequency transceiver 903 provided on each of the tactile capacitance sensors 101 and a radio frequency transceiver 901 provided on the control unit 103 as disclosed in the detailed description of FIG. 9B.

The control unit 103 monitors and captures 1304 the capacitance readings of each of the tactile capacitance sensors 101. The control unit 103 detects and continuously transmits 1305 the captured capacitance readings to the software 104a on the computing device 104. The software 104a processes 1306 and evaluates the transmitted capacitance readings into on/off logic for command instructions and/or emulation output. The software 104a receives and translates the capacitance readings to a single or multiple custom outputs on the computing device 104. The software 104a emulates output functionality by mapping the tactile capacitance sensors 101 positioned on the periphery 102a of the rings 102 to one or more custom outputs on the computing device 104.

In an embodiment, the control unit 103 continuously transmits the capacitance readings of a proximity-based nature. The capacitance readings from each of the tactile capacitance sensors 101 change as the user's thumb 202e is brought closer to the tactile capacitance sensors 101 on the fingers 202a, 202c, 202d, and 202f. Capacitance sensing can use an alternating voltage which causes the charges to continually reverse their positions. The movement of the charges creates an alternating electric current which is detected by the control unit 103 and subsequently transmitted to the computing device 104. The amount of current flow is determined by the capacitance, and the capacitance is determined by the proximity of the conductive object. Therefore, bringing the user's thumb 202e closer to the tactile capacitance sensor 101 causes greater current.

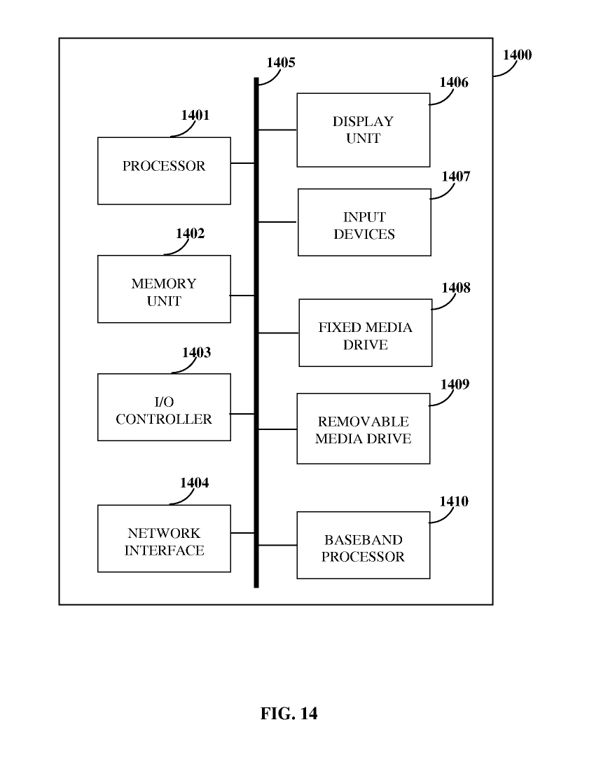

FIG. 14 exemplarily illustrates the architecture of a computer system 1400 employed for processing capacitance readings of each of the tactile capacitance sensors 101 positioned on periphery 102a of the rings 102 into one or more custom outputs on the computing device 104. The software 104a is deployed on, for example, the computer system 1400 of the computing device 104.

The computing device 104 communicates with the control unit 103 by wired communication, wireless communication, or a combination thereof. The transmission modes are, for example, a USB 2.0 data interface, radio frequency transmitter or transceiver and receiver, etc. The computer system 1400 comprises, for example, a processor 1401, a memory unit 1402 for storing programs and data, an input/output (I/O) controller 1403, a network interface 1404, a network bus 1405, a display unit 1406, input devices 1407, a fixed media drive 1408, a removable media drive 1409, a baseband processor 1410, etc.

The processor 1401 is an electronic circuit that executes computer programs. The memory unit 1402 is used for storing programs and applications. The software 104a is, for example, stored on the memory unit 1402 of the computer system 1400. The memory unit 1402 is, for example, a random access memory (RAM) or another type of dynamic storage device that stores information and instructions for execution by the processor 1401. The memory unit 1402 also stores temporary variables and other intermediate information used during execution of the instructions by the processor 1401. The computer system 1400 further comprises a read only memory (ROM) or another type of static storage device that stores static information and instructions for the processor 1401. The network interface 1404 enables connection of the computer system 1400 to the tactile input apparatus 100. In case of a mobile computing device, the network interface 1404 connects the computing device 104 wirelessly to the tactile input apparatus 100. The computing device 104 further comprises a baseband processor 1410 for processing communication functions and managing communication transactions with the tactile input apparatus 100. The I/O controller 1403 controls the input and output actions performed by the user. The network bus 1405 permits communication between the modules of the software 104a.

The display unit 1406 displays computed results on the user interface of the computing device 104. The input devices 1407, for example, the tactile input apparatus 100 disclosed herein, inputs data into the computer system 1400. The computer system 1400 further comprises a fixed media drive 1408 and a removable media drive 1409 for receiving removable media.

Computer applications and programs are used for operating the computer system 1400. The programs are loaded onto the fixed media drive 1408 and into the memory unit 1402 of the computer system 1400 via the removable media drive 1409. In an embodiment, the computer applications and programs may be loaded directly through the tactile input apparatus 100. Computer applications and programs are executed by double clicking a related icon displayed on the display unit 1406 using one of the input devices 1407. The user interacts with the computer system 1400 using a graphical user interface (GUI) of the display unit 1406.

The computer system 1400 of the computing device 104 employs operating systems for performing multiple tasks. An operating system is responsible for the management and coordination of activities and the sharing of the resources of the computer system 1400. The operating system further manages security of the computer system 1400, peripheral devices connected to the computer system 1400, and network connections. The operating system employed on the computer system 1400 recognizes, for example, inputs provided by the user using one of the input devices 1407, the output display, files and directories stored locally on the fixed media drive 1408, etc. The operating system on the computer system 1400 of the user executes different programs initiated by the user using the processor 1401. Instructions for executing the software 104a are retrieved by the processor 1401 from the program memory in the form of signals. The location of the instructions in the program memory is determined by a program counter (PC). The program counter stores a number that identifies the current position in the program of the software 104a.

The instructions fetched by the processor 1401 from the program memory after being processed are decoded. After processing and decoding, the processor 1401 executes the instructions. For example, the software 104a defines instructions for processing the capacitance readings of each of the tactile capacitance sensors 101 to one or more custom outputs on the computing device 104. The defined instructions are stored in the program memory or received from a remote server. The processor 1401 retrieves the instructions defined by the software 104a and executes the instructions.

Consider an example application, wherein a user is wearing four tactile capacitance sensors 101 on four fingers 202a, 202c, 202d, and 202f, leaving the thumb 202e bare. The user employs the software 104a on the computing device 104 to map or assign a particular keystroke to a particular tactile capacitance sensor 101 on, for example, the index finger 202a via the GUI. The particular keystroke and its respective tactile capacitance sensor 101 are linked, and any touch to the index finger 202a triggers the desired keystroke output. Keystroke emulation is based on the logic of the software 104a analyzing the streaming capacitance readings from the tactile capacitance sensors 101 via the control unit 103.

Other applications include industrial and marketplace usage that involve movement and control of, for example, machinery, vehicles, and heavy equipment, etc. As another example, factory controls can also be tied to the on and off sensor logic provided by the tactile capacitance sensors 101 on the fingertips, effectively putting the command keys on a user's fingertips for multiple factory operations.

In another example, the tactile input apparatus 100 provides an engaging system for patients who are physically rehabilitating, for example, injured fingers, hands, and/or wrists, etc. The tactile capacitance sensors 101 provide a method to achieve contact from fingertip to the thumb tip or from fingertip to the palm 204b. This movement can be tied to controls for games that challenge, occupy and reward the patient, thereby reducing or minimizing the patient's awareness and consideration of the pain involved. The distraction of a game during rehabilitation can greatly reduce a patient's awareness of pain and consequent suffering due the painful and repetitive hand exercises required by the physical rehabilitation of certain hand, finger, and/or wrist injuries.

Consider another example, where the tactile input apparatus 100 emulates keystrokes of a key board. Four tactile capacitance sensors 101, for example, sensor 1, sensor, 2, sensor 3, and sensor 4, are mounted on the user's index finger 202a, middle finger 202c, ring finger 202d, and little finger 202f respectively. Sensor 1 on the index finger 202a is mapped to the keystroke “W” of the keyboard. Sensor 2 in the middle finger 202c is mapped to the keystroke “A” of the keyboard. Sensor 3 on the ring finger 202d is mapped to the keystroke “S” of the keyboard. Sensor 4 on the little finger 202f is mapped to the keystroke “D” of the keyboard. This mapping of tactile capacitance sensors 101 causes the computing device 104 to process the above key strokes when respective tactile capacitance sensors 101 are contacted by the user's thumb 202e.

A contact between the thumb 202e or palm 204b of the user and the tactile capacitance sensor 101 on the periphery 102a of a ring 102 establishes change in capacitance of the tactile capacitance sensor 101 causing the tactile capacitance sensor 101 to drop from a high capacitance reading of, for example, about 2000 picofarads or more, to a significantly lower reading, ideally nearing zero. These capacitance readings of each tactile capacitance sensor 101 are monitored and continuously transmitted by the control unit 103. The capacitance readings are received and translated to an output signal by the software 104a running on the computing device 104. For example, when the user's bare thumb 202e touches the sensor 1 on the underside 202b of the index finger 202a, the output “W” is displayed on the computing device 104. When the user's bare thumb 202e touches the sensor 2 on the underside 202b of the middle finger 202c, the output “A” is displayed on the computing device 104. When the user's bare thumb 202e touches the sensor 3 on the underside 202b of the ring finger 202d, the output “S” is displayed on the computing device 104. When the user's bare thumb 202e touches the sensor 4 on the underside 202b of the little finger 202f, the output “D” is displayed on the computing device 104.

Consider another example, where a contact between the thumb 202e or any other finger of the user and the tactile capacitance sensor 101 on the periphery 102a of each of the rings 102 establishes change in capacitance of the tactile capacitance sensor 101. The capacitance readings of each tactile capacitance sensor 101 are monitored and captured by the control unit 103. The capacitance readings are received and processed into one or more custom outputs on, for example, a video game console device, by the software 104a. For example, a contact between the thumb 202e and the tactile capacitance sensor 101 on the periphery 102a of the ring 102 mounted on the user's index finger 202a is programmed to imply an action, for example, of changing a gaming tool” in a simulation game involving different gaming tools, that has already been assigned to the capacitance readings of each tactile capacitance sensor 101 mounted on the index finger 202a. The capacitance readings of each tactile capacitance sensor 101 mounted on the index finger 202a can be reassigned to a different functional action, for example, “reloading the gaming tool”, etc.

It will be readily apparent that the various methods and algorithms described herein may be implemented in a computer readable medium appropriately programmed for general purpose computers, game consoles, and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Common forms of computer readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer readable programs may be implemented in any programming language. Some examples of languages that can be used include C, C++, C#, Perl, Python, or JAVA. The software programs may be stored on or in one or more mediums as an object code. A computer program product comprising computer executable instructions embodied in a computer readable medium comprises computer parsable codes for the implementation of the processes of various embodiments.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A tactile input apparatus, comprising:
generally ring-shaped elements configured to conform to fingers of a user, wherein said generally ring-shaped elements are mounted on said fingers of said user;
tactile capacitance sensors operably affixed to periphery of said generally ring-shaped elements, wherein said tactile capacitance sensors are positioned adjacent and parallel to underside of said fingers, wherein each of said tactile capacitance sensors undergoes a change in capacitance on establishing contact with one of a finger, a thumb, and a palm of said user;
a control unit in electronic communication with each of said tactile capacitance sensors, wherein said control unit monitors each of said tactile capacitance sensors and continuously captures capacitance readings of each of said tactile capacitance sensors; and
said control unit in communication with a software provided on a computing device of said user for continuously transmitting said capacitance readings, wherein said software receives and translates said capacitance readings to one or more custom outputs on said computing device;
whereby said positioning of said tactile capacitance sensors on said periphery of said generally ring-shaped elements prevents confinement of said fingers and hand of said user and allows mobility of said fingers of said user.

2. The tactile input apparatus of claim 1, wherein said electronic communication between each of said tactile capacitance sensors and said control unit is one of a wired communication, a wireless communication, and a combination thereof.

3. The tactile input apparatus of claim 1, wherein said electronic communication between said control unit and said computing device is one of a wired communication, a wireless communication, and a combination thereof.

4. The tactile input apparatus of claim 1, wherein said control unit comprises a capacitance touch sensing chip and a microcontroller for monitoring each of said tactile capacitance sensors and capturing said capacitance readings of said tactile capacitance sensors, wherein said control unit utilizes said capacitance touch sensing chip and said microcontroller to detect and assign logic to said captured capacitance readings of each of said tactile capacitance sensors.

5. The tactile input apparatus of claim 1, wherein said control unit is mounted on said periphery of each of said generally ring-shaped elements and is in one of a wired communication and a wireless communication with said computing device.

6. The tactile input apparatus of claim 1, wherein said control unit is mounted external to each of said generally ring-shaped elements and is in one of a wireless communication and a wired communication with said computing device.

7. The tactile input apparatus of claim 1, further comprising a radio frequency transceiver on each of said tactile capacitance sensors and said control unit for wirelessly communicating with said control unit and said computing device respectively.

8. The tactile input apparatus of claim 1, further comprising an energy storage device mounted on each of said generally ring-shaped elements for powering said tactile capacitance sensors and said control unit.

9. The tactile input apparatus of claim 1, further comprising a wireless power source for transferring power to each of said tactile capacitance sensors on said periphery of said generally ring-shaped elements via a near field communication.

10. The tactile input apparatus of claim 1, wherein said user provides input by contacting one of said thumb and said palm with one or more of said tactile capacitance sensors, wherein said contact invokes said change in capacitance of said tactile capacitance sensors.

11. The tactile input apparatus of claim 10, wherein said software emulates said input by mapping said tactile capacitance sensors positioned on said periphery of said generally ring-shaped elements to an action on said computing device.

12. The tactile input apparatus of claim 1, wherein said software provides a graphical user interface for enabling said user to customize emulation of a plurality of output actions on said computing device.

13. The tactile input apparatus of claim 1 being configured to function as one of a standalone device and in conjunction with external devices.

14. The tactile input apparatus of claim 1, further comprising wires extending from each of said tactile capacitance sensors on said periphery of said generally ring-shaped elements to said control unit for communicating said capacitance readings to said control unit, wherein said extended wires are grouped and attached to a band wearable by said user.

15. A method for providing input to a computing device by a user, comprising:
providing a tactile input apparatus, comprising:
generally ring-shaped elements configured to conform to fingers of a user, wherein said generally ring-shaped elements are mounted on said fingers of said user;
tactile capacitance sensors operably affixed to periphery of said generally ring-shaped elements, wherein said tactile capacitance sensors are positioned adjacent and parallel to underside of said fingers;
a control unit in electronic communication with each of said tactile capacitance sensors positioned on said generally ring-shaped elements; and
said control unit in electronic communication with a software provided on said computing device of said user;
strategically positioning at least four of said generally ring-shaped elements onto four of said fingers of said user;
establishing contact between one of a finger, a thumb, and a palm of said user and one or more of said tactile capacitance sensors, wherein each of said tactile capacitance sensors undergoes a change in capacitance on contacting one of said finger, said thumb, and said palm of said user;
monitoring and capturing capacitance readings of each of said tactile capacitance sensors by said control unit;
continuously transmitting said captured capacitance readings to said software on said computing device of said user; and
processing said transmitted capacitance readings into one or more custom outputs on said computing device, by said software on said computing device.

16. The method of claim 15, wherein said electronic communication between each of said tactile capacitance sensors and said control unit is one of a wired communication, a wireless communication, and a combination thereof.

17. The method of claim 15, wherein said electronic communication between said control unit and said computing device is one of a wired communication, a wireless communication, or a combination thereof.

18. The method of claim 15, wherein said control unit utilizes a capacitance touch sensing chip and a microcontroller to detect and assign logic to said captured capacitance readings of each of said tactile capacitance sensors.

19. The method of claim 15, wherein said software emulates output functionality by mapping said tactile capacitance sensors positioned on said periphery of said generally ring-shaped elements to said custom outputs on said computing device.

20. The method of claim 15, further comprising customizing emulation of a plurality of output actions on said computing device by said user using a graphical user interface provided by said software on said computing device.

21. The method of claim 15, further comprising communicating said capacitance readings to said control unit by one of a wired communication and a wireless communication, wherein said wired communication is established using a plurality of wires extending from each of said tactile capacitance sensors to said control unit, and wherein said wireless communication is established using a radio frequency transceiver provided on each of said tactile capacitance sensors and said control unit.

22. A computer program product comprising computer executable instructions embodied in a computer readable storage medium, wherein said computer program product comprises:
a first computer parsable program code for monitoring tactile capacitance sensors positioned on generally ring-shaped elements of a tactile input apparatus, wherein said generally ring-shaped elements are mounted on fingers of a user, wherein each of said tactile capacitance sensors undergoes a change in capacitance on contacting one of a finger, a thumb, and a palm of said user;
a second computer parsable program code for receiving capacitance readings of each of the tactile capacitance sensors transmitted by said control unit, by a software provided on a computing device of said user; and
a third computer parsable program code for processing said capacitance readings into one or more custom outputs on said computing device.
